(19) United States
(12) Patent Application Publication
(10) Pub. No.: US 2014/0337224 A1
(43) Pub. Date: Nov. 13, 2014

(54) Cardholder Changeable CVV2

(71) Applicant: Sarada Mohapatra, Naperville, IL (US)

(72) Inventor: Sarada Mohapatra, Naperville, IL (US)

(21) Appl. No.: 14/270,644

(22) Filed: May 6, 2014

Related U.S. Application Data
(60) Provisional application No. 61/820,170, filed on May 7, 2013.

(51) Int. Cl. G06Q 20/40; G06Q 20/24

(52) U.S. Cl. CPC G06Q 20/4018; G06Q 20/24
USPC 705/44

(57) ABSTRACT

System and methods for countering credit card fraud comprising cardholder changeable card security code CVV2 (also known as CVC2/CID). It enables cardholder to optionally choose a CVV2 different from the one printed on the card, storing/recording it on card issuer database and from then on use it as a secret separate from the card, changing it as needed, for example on being notified of financial institution data breach, or after an online transaction that seemed risky or periodically as a security practice. Fraudulent authorization requests would be rejected when CVV2 submitted does not match cardholder changed value. This system may be implemented with no or modest change in existing credit cards; terminals, equipment, computer software and communication protocols used in transaction authorization. It may facilitate adoption by making cardholders active participants in fraud prevention with modest, optional, easy to comprehend change not tied to each transaction.

### CROSS-REFERENCE TO RELATED APPLICATIONS

This application is a continuation of, and claims priority to, U.S. patent application Ser. No. 61/820,170, entitled “Cardholder Changeable CVV2” filed on May 7, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

Credit card use for payment of goods and services in card-present as well as card-not-present transactions has been increasing in number as well as value. Along with usage, credit card fraud has increased.

In response, measures have been and are being adopted to prevent and detect fraud. Most preventive measures involve issuers, acquiring banks, merchants and card networks with expectation from cardholders limited to fraud detection by monitoring card accounts and promptly reporting lost cards and fraudulent charges. Turning millions of cardholders into first line of defense would be an effective part of a multi-layer anti-fraud strategy. Near ubiquitous Internet connectivity and increasing use of issuer provided secure web portals for credit card account management as well as mobile device account management applications may facilitate cardholder participation in preventive anti-fraud measures on an ongoing basis.

Enlisting cardholders in fraud prevention would additionally leverage cardholder's knowledge and risk assessment specific to him/her. A cardholder may recognize increased fraud risk, for example, after clicking a link in an unexpected email which could be a phishing attack, after using an ecommerce site that is not reputable and after a vacation where card is used in unfamiliar establishments far from home and thus be motivated to undertake mitigating action if provided capability to do so.

All the data used to authenticate cardholders of regular non-chip credits cards and used during credit card authorizations are currently static. In addition to card account number, card holder name, expiration month-year that are visible on the card, the card security information in the magnetic strip and card security code (also known as CVV2 , CVC2 or CID) do not change from the time a card is issued. Elements of cardholder's identity often used for additional authentication such as address, billing zip code also usually do not change. This makes it possible for fraudulent charges to get authorized days, weeks and sometimes months after card details are compromised.

In recent years, there have been many computer data breaches where personal and financial information including credit card information on computer systems of merchants, ecommerce sites, corporations and government agencies were compromised. The frequency and high number of credit card accounts involved, sometimes numbering in millions, make it costly for issuers and inconvenient to cardholders to replace all the cards in each instance. The cardholders are notified of the data breach due to notification laws in many jurisdictions. These notifications may trigger mitigating action on part of cardholder if means to do so were available.

Adoption of various fraud prevention measures have often been constrained by substantial cost of technology and change requirements to issuers, merchants, acquirers and card networks. Cardholders have not embraced some of the technologies due to additional and/or unfamiliar steps.

Thus, there is a need for fraud prevention measure where cardholder plays an active role, which enables cardholder to respond to risks as they are identified, which does not greatly alter the ease and convenience of every day card use for the cardholders and reduces fraud risks without greatly increased costs and overheads.

### SUMMARY

Accordingly, embodiments of the present invention may reduce credit card fraud by enabling cardholders to play an active role in fraud prevention and react to fraud risk events without greatly increased costs and overheads.

An illustrative embodiment of the present invention may provide capabilities for cardholders to choose a CVV2 different from the one printed on the card when issued, storing/recording it on card issuer database and from then on use it as a secret separate from the card, changing it as needed, for example on being notified of financial institution data breach, or after an online transaction that seemed risky or periodically as a security practice.

An embodiment of the present invention may be implemented with no or modest change in existing credit cards, terminals, equipment, computer software and communication protocols used in transaction authorization; thus reducing of cost of deployment.

An embodiment of the present invention may require no or modest change to transaction authorization and thus the impact on day to day cardholder experience may not be significant. Cardholders who choose not to change CVV2 printed on the card would see no change, thus allowing for an evolutionary adoption.

In various embodiments of the present invention, changing nature of CVV2 may protect against fraudulent charges based on compromised or stolen credit card data when CVV2 is part of authorization as effectively as card replacement—at less cost to issuer and less inconvenience to cardholder.

Various embodiments of the present invention may incorporate one or more of these and other features described herein. A better understanding of the nature and advantages of the present invention may be gained by reference to following detailed description and accompanying drawings.

### BRIEF DESCRIPTION OF DRAWINGS

FIG. 1 Illustrates an exemplary timeline depicting timely change of CVV2 by cardholder preventing a fraudulent charge.

FIG. 2 Illustrates an exemplary system of cardholder changeable CVV2.

FIG. 3 Illustrates an exemplary e-commerce form used in card-not-present transaction depicting change for this invention being limited to the help information.

FIG. 4 Illustrates an exemplary automated fuel dispenser in card-not-present transaction where CVV2 is used instead of Zip code.

FIG. 5 Illustrates a card with CVV2 blacked-out to prompt merchant to ask cardholder for CVV2 in a card-present transaction where CVV2 is used in authorization.

### DETAILED DESCRIPTIONS

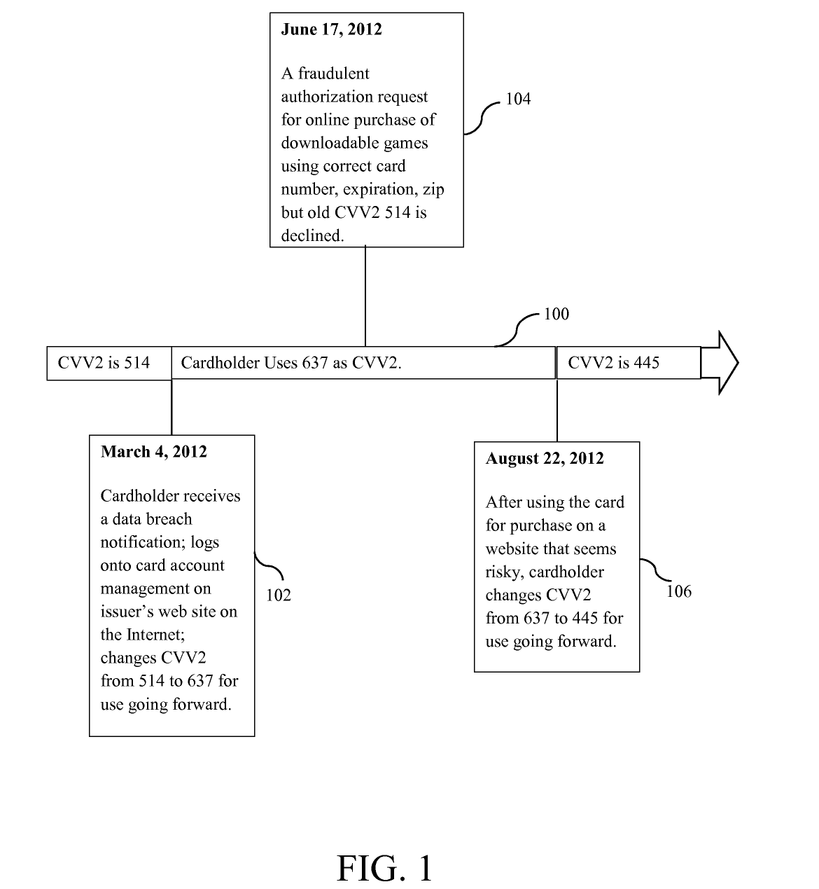

FIG. 1 is a diagram illustrating an example timeline 100 showing one cardholder changing CVV2 value based on his knowledge and risk perception over a period. It depicts cardholder changing CVV2 in response to example event 102 receipt of data breach notification. Subsequent fraudulent attempt using compromised data 104 fails due to submitted CVV2 based on compromised data no longer being valid. This is often the case that there is a time lag between skimmers, hackers obtaining credit card data and its use by criminals who often purchase it from them. A later event 106 shows cardholder changing CVV2 after a web purchase where cardholder perceives the site to be risky.

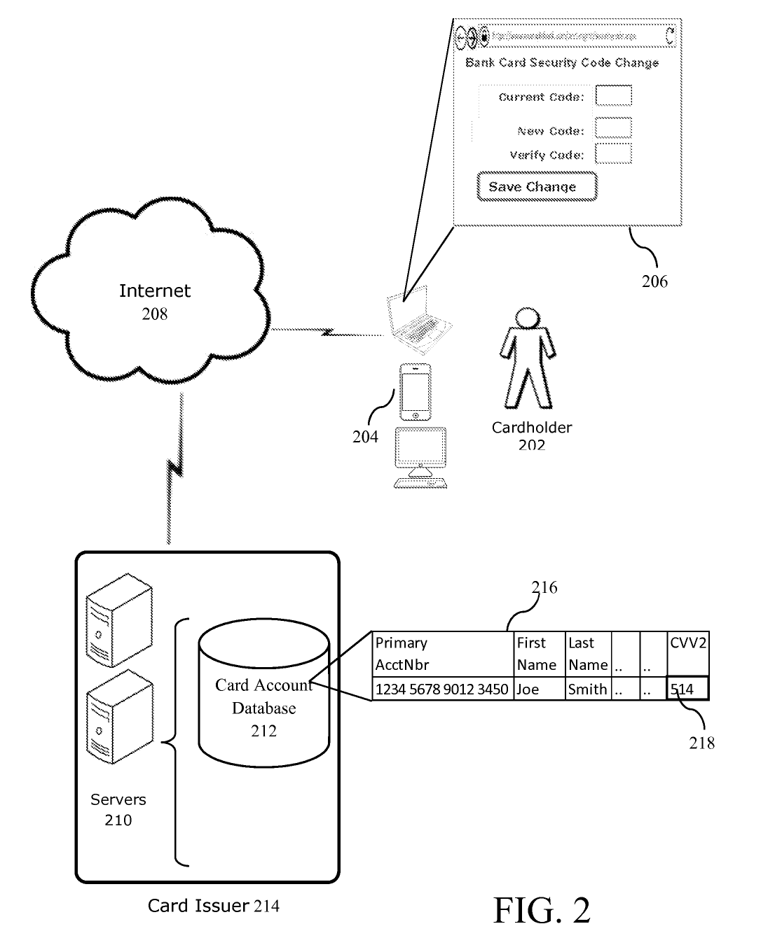

FIG. 2 is a diagram illustrating an example system where cardholder 202 uses an internet connected device 204 which may be a personal computer or mobile device to securely communicate with software applications hosted on servers 210 in data center of card issuer 214. Cardholder may use a web browser or an issuer provided application to choose a new CVV2. An example of user interface 206 as part of authenticated and encrypted web session is shown. The application securely stores the cardholder chosen CVV2 on issuer's card account database 212 with new CVV2 value 218 stored in account record 216 in encrypted form so as not be compromised even in case of data loss.

Cardholder may change CVV2 as often as s/he wants. Since merchants, acquirers and payment processors are prohibited from storing CVV2 for PCI DSS compliance, authorization requests will be verified with the current value of CVV2 in issuer database and will be unambiguous even when an authorization request follows soon after a CVV2 change.

In a specific embodiment, certain cardholder chosen CVV2 values may indicate specific purpose. For example, cardholder may choose CVV2 value 000 to indicate all card-not-present transactions be declined, possibly for a card that cardholder has designated only for local in-store use.

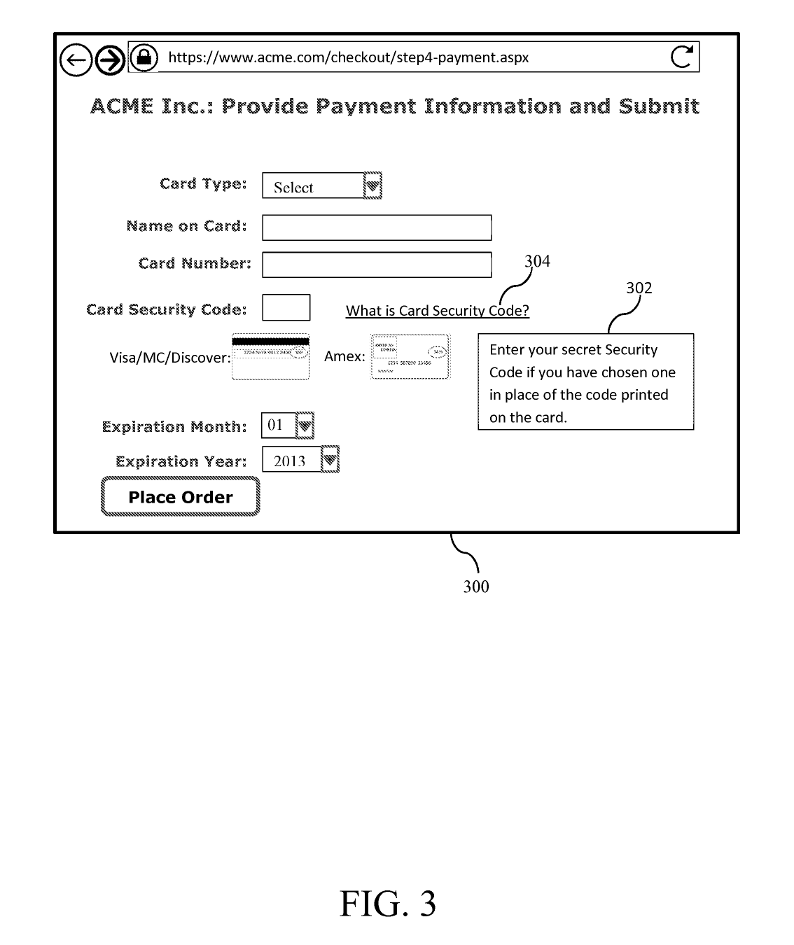

FIG. 3 illustrates a card-not-present transaction which embodies present invention. It shows an exemplary web form 300 which is usually the final step of an ecommerce site's checkout process where payment details are submitted. Cardholder changeable CVV2 adds the note block 302 informing the cardholders to use secret CVV2 if changed from one printed on the card. Help information link 304 on CVV2 commonly found on many ecommerce sites would be similarly enhanced. Thus, the changes for this embodiment to the ecommerce sites are small, simple, low-risk changes to static help content.

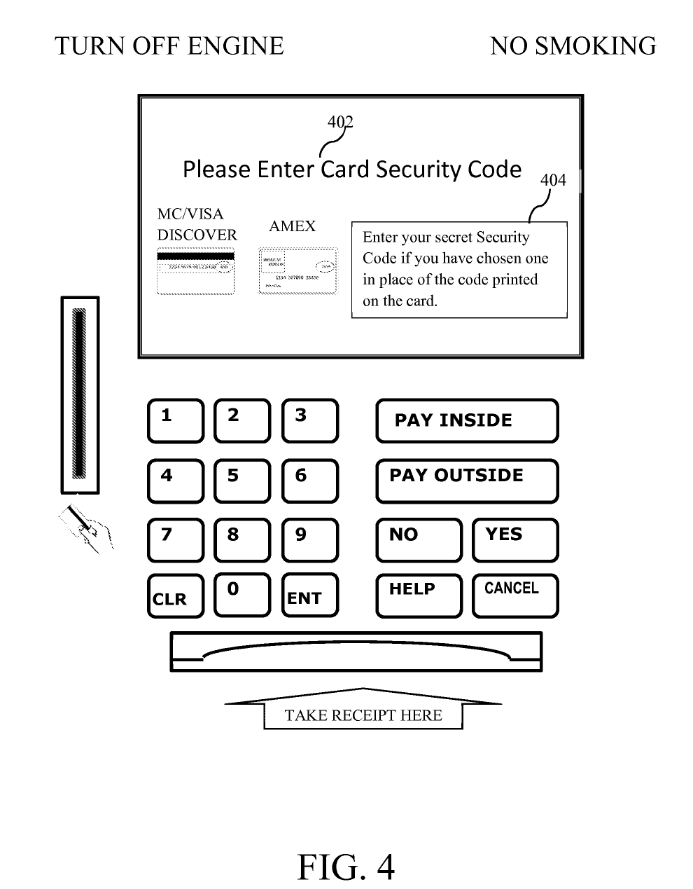

FIG. 4 illustrates an Automated Fuel Dispenser (AFD), widely used source of card-not-present transactions, embodying present invention. In place of using billing zip code and AVS query for verification, the software has been changed to prompt for CVV2 402 along with help information 404 and do a CVV2 query for verification. Cardholder changing CVV2 periodically or soon after a road trip where card was used at some gas stations with inadequate security would be protected even if the CVV2 is compromised by skimming. CVV2 based verification would also help Canadian cardholders with alphanumeric billing zip code travelling in the USA.

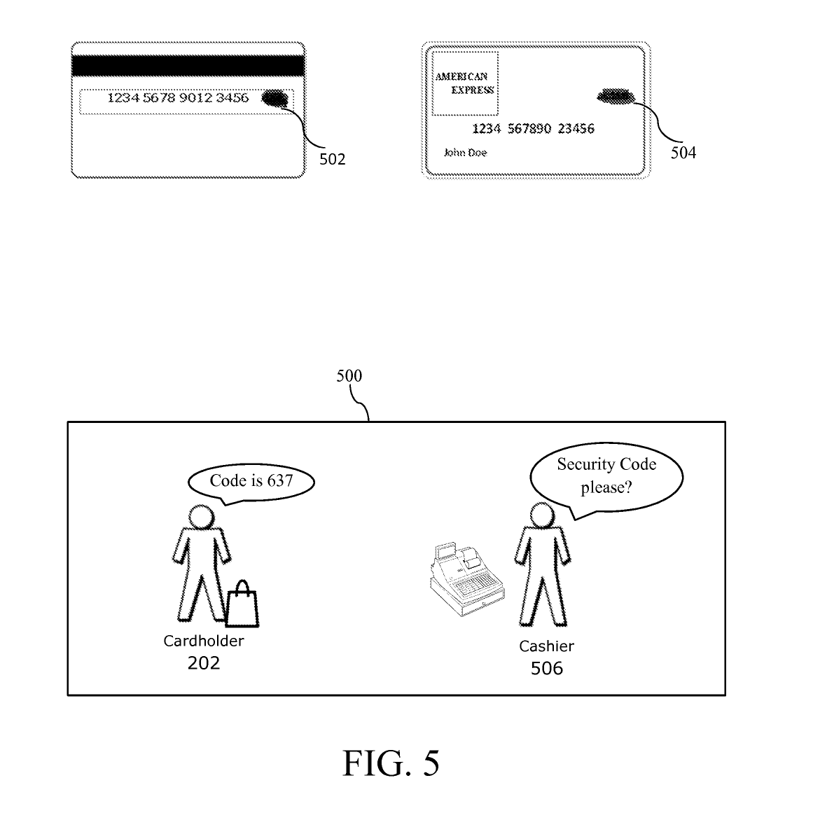

FIG. 5 illustrates embodiment of present invention in a card-present transaction. Cardholder may black out the CVV2 printed on the card as shown in 502 and 504 using, for example, a permanent marker at the time of first change of CVV2 to a personal secret. In the exemplary check-out 500, cashier 506 asks cardholder 202 for the “security code”. Unlike zip code which has been deemed to be personally identifiable information in some jurisdictions, cardholder may tell the cashier CVV2 safe with the knowledge even if it is somehow recorded and associated with the card account number; s/he will change it before it can be exploited. The masking of CVV2 also eliminates the risk of skimming when card is out of cardholder's sight as in a restaurant. In another embodiment, the issuer may omit CVV2 or print a pattern such as XXX; letting the cardholder setup the initial CVV2.

The above description of embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of following claims.

What is claimed is:

1. A method for countering credit card fraud comprising cardholder changeable card security code known as CVV2.

2. The method of claim 1 further comprising:
Cardholder choosing a CVV2 value different from the one printed on the card on first change and a different new value for subsequent changes;
Cardholder recording the chosen CVV2 value with the card issuer;
Card issuer using most recently recorded CVV2 to verify CVV2 provided in transaction authorization requests that follow.

3. The method of claim 2 wherein recording the chosen CVV2 value with card issuer step is accomplished by the cardholder using a issuer provided facility over the Internet.

4. The method of claim 3 further comprising:
A web application on issuer's server;
Cardholder accessing the application via secure web session using a browser.

5. The method of claim 4 wherein the web application is a feature of online card management system.

6. The method of claim 3 further comprising:
Issuer provided application, also known as app, for mobile devices such as smartphones, tablets;
Cardholder using the app along with internet connectivity to securely communicate with issuer's server.

7. The method of claim 6 wherein the app is a feature of card account management app.

8. The method of claim 1 further comprising cardholders using CVV2 along with the card for authentication of transactions where currently there is no additional verification or additional verification is based on static information.

9. The method of claim 2 wherein certain specific chosen CVV2 values have specific purpose.
